(19) United States
(12) Patent Application Publication
(10) Pub. No.: US 2008/0111879 A1
(43) Pub. Date: May 15, 2008

(54) Method for Determining Correction Value, Exposure Device, and Image Forming Apparatus

(75) Inventors: Yoshio ARAI, Shiojiri-shi (JP); Nozomu INOUE, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/833,569

(22) Filed: Aug. 3, 2007

(30) Foreign Application Priority Data
Nov. 9, 2006 (JP) 2006-303653

(51) Int. Cl. B41J 2/45

(52) U.S. Cl. 347/238

(57) ABSTRACT

A method for determining a correction value used for correction of energy of light emitted from each of a plurality of light-emitting elements for exposing a surface to be exposed, the light-emitting elements being arranged in a first direction, is provided. The method includes identifying, from among a plurality of spot regions formed on the surface in response to the light being emitted from the plurality of light-emitting elements, an elongated spot region whose major axis extends in a direction inclined with respect to the first direction and determining a correction value such that a dimension of the identified spot region in a direction of the major axis is made to be equal or close to a target value.

### BACKGROUND

1. Technical Field

The present invent ion relates to a technique for correcting energy of light emitted from a plurality of light-emitting elements.

2. Related Art

Electrophotographic image forming apparatuses that form a latent image on a surface of an image bearing member, such as a photosensitive drum, by exposure using a plurality of light-emitting elements (the surface is a surface to be exposed and hereinafter referred to as an “exposure surface”) have been proposed. If there exist variations in characteristics of each of the light-emitting elements or characteristics of an active element that drives the light-emitting element (deviation from a design value or variations among elements), sizes of regions in the exposure surface radiated with light emitted from the light-emitting elements (hereinafter referred to as “spot regions”, vary among the light-emitting elements. This causes a problem or non-uniformity of a gray-scale level (density) To address the problem, for example, Japanese Patent No. 3,233,834 discloses a technique for correcting energy of light emitted from light-emitting elements so as to make dimensions (diameters) along the main scanning direction and the sub-scanning direction uniform over all spot regions.

However, the spot regions may have variations in shape, in addition to simple size (diameter) variations. For example, the plurality of spot regions may be deformed in different directions. In particular, for a structure in which light emitted from light-emitting elements reaches an exposure surface through various condensing units (e.g., gradient-index lenses), variations in shape among the spot regions resulting from the difference in positional relationships between the light-emitting elements and the optical axes of the respective condensing units become marked. A problem arises that it is difficult for a technique based on the premise that each of the spot regions has a circular shape, as described in the above-mentioned patent document, to sufficiently suppress non-uniformity of a gray-scale level resulting from variations in shape among spot regions.

### SUMMARY

An advantage of some aspects of the invention is that it suppresses adverse effects of variations in shape among spot regions.

According to a first aspect of the invention, a method for determining a correction value used for correction of energy of light emitted from each of a plurality of light-emitting elements for exposing a surface to be exposed, the light-emitting elements being arranged in a first direction, is provided. The method includes identifying, from among a plurality of spot regions formed on the surface in response to the light being emitted from the plurality of light-emitting elements, an elongated (e.g., elliptical) spot region whose major axis extends in a direction inclined with respect to the first direction and determining a correction value such that a dimension of the identified spot region in a direction of the major axis is made to be equal or close to a target value.

In accordance with the above method, since the correction value is determined such that the dimension of the spot region in the direction of the major axis inclined with respect to the first direction is made to be equal or close to the target value, adverse effects of variations in shape among the spot regions (for example, non-uniformity of a gray-scale level) can be suppressed more effectively than a method disclosed in the above-mentioned patent document. “Inclined with respect to the first direction” indicates a state in which an elevation angle to the first direction is an angle other than an integral multiple of 90°.

In a structure in which the light emitted from the light-emitting elements passes through a plurality of converging units (e.g., gradient-index lenses or microlenses) arranged across the first direction and a second direction inclined with respect to the first direction and then reaches the surface, the direction of the major axis of the spot region may match or approximate the second direction. Therefore, the correction value may be determined such that a dimension of the identified spot region in the second direction is made to be equal or close to the target value. In accordance with the above aspect, since the correction value is determined on the basis of the dimension of the spot region in a direction of alignment of the converging units, an operation of strictly measuring the direction of the major axis of each of the spot regions is not required.

Preferably, the correction value may be determined on the basis of a relationship between a direction of a screen angle of an image formed on the surface and the direction of the major axis of the identified spot region. The adverse effects of variations in shape among spot regions are particularly marked when a screen (halftone screen) is used. For example, when a spot region has an elongated shape whose major axis extends in the direction of the screen angle and another spot region has an elongated shape whose major axis extends in a direction that is substantially perpendicular to the direction of the screen angle, non-uniformity of a gray-scale level is apt to be marked because the degree of overlapping of the spot region and its adjacent spot region is different. As a result, the invention that can reduce the adverse effects of variations in shape among the spot regions is particularly suited for when a screen is used, as in a case described above.

According to a second aspect of the invention, a method for determining a correction value used for correction of energy of light emitted from each of a plurality of light-emitting elements for exposing a surface to be exposed, the light-emitting elements being arranged in a first direction, is provided. The method includes identifying, from among a plurality of spot regions formed on the surface in response to the light being emitted from the plurality of light-emitting elements, an elongated spot region (e.g., a spot region S2 illustrated in FIG. 4) whose major axis extends in a first axial direction (e.g., a P direction illustrated in FIG. 4) inclined with respect to the first direction and an elongated spot region (e.g., a spot region S4 illustrated in FIG. 4) whose major axis extends in a second axial direction (e.g., a Q direction Illustrated in FIG. 4), the second axial direction being inclined with respect to the first direction in a direction different from the first axial direction, and identifying the first axial direction and the second axial direction and determining, for each of the plurality of light-emitting elements, a correction value on the basis of a difference value between a dimension in the first axial direction and a dimension in the second axial direction of a spot region formed by the plurality of light-emitting element. Also in this aspect, since the correction value is determined on the basis of the dimension in the first axial direction and the dimension in the second axial direction, which are both inclined with respect to the first direction, adverse effects of variations in shape among the spot regions (for example, non-uniformity of a gray-scale level) can be suppressed more effectively than a method disclosed in the above-mentioned patent document. Moreover, since the correction value is determined on the basis of the difference value between the dimension in the first axial direction and the dimension in the second axial direction, the invention also has the advantage of allowing a method for determining a correction value to be common to a spot region whose manor axis extends in the first axial direction and a spot region whose major axis extends in the second axial direction.

According to another aspect of the invention, an exposure device that drives a light-emitting element on the basis of a correction value determined by a method for determining a correction value according to at least one aspect described above is provided. The exposure device according to at least one of the aspects includes a plurality of light-emitting elements that expose a surface to be exposed, the plurality of light-emitting elements being arranged in a first direction and a storage circuit (e.g., a storage circuit 12 illustrated in FIGS. 2 and 9) that stores a correction value for each of the plurality of light-emitting elements. The exposure device controls energy of light emitted from the light-emitting element on the basis of the correction value for the light-emitting element. The correction value stored in the storage circuit has been determined such that a dimension of an elongated spot region whose major axis extends in a direction inclined with respect to the first direction in a direction of the major axis, the elongated spot region being identified from a plurality of spot regions formed on the surface in response to the light being emitted from the plurality of light-emitting elements, is made to be equal or close to a target value. In accordance with the exposure device described above, uniform exposure based on the correction value determined so as to reduce the adverse effects of variations in shape among the spot regions can be achieved.

The exposure device can be used in various kinds of electronic apparatuses For example, an image forming apparatus according to an aspect of the invention includes an exposure device according to an aspect of the invention, an image bearing mender (e.g., a photosensitive drum 70) having the surface on which a latent image is to be formed by exposure performed by the exposure device, and a developing unit that forms a visible image by applying a developer (e.g., toner) to the latent image formed on the image bearing member. In accordance with the exposure device according to at least one of aspects of the invention, uniform exposure can be achieved. Therefore, the image forming apparatus according to an aspect of the invention can form a high-quality image that satisfactorily suppresses non-uniformity of a gray-scale level.

Applications of the exposure device according to an aspect of the invention are not limited to exposure to an image bearing member. For example, in an image reading apparatus, such as a scanner, the exposure device according to an aspect of the invention can be used as a lighting device for documents. The image reading apparatus includes the exposure device according to an aspect of the invention and a light-receiving device that converts light reflected from a reading target (document) after having been emitted from the exposure device (e.g., a light receiving element, such as a charge coupled device (CCD) element).

### BRIEF DESCRIPTION OF THE DRAWINGS

The invention will be described with reference to the accompanying drawings, wherein like numbers reference like elements.

FIG. 1 is a cross-sectional view illustrating a partial structure of an image forming apparatus according to a first embodiment.

FIG. 2 is a block diagram illustrating an electric structure of an exposure device and a control device.

FIG. 3 is a plan view illustrating a structure of a converging-lens array.

FIG. 4 illustrates conceptual drawings of the shapes of spot regions formed in the case where correction has not been made.

FIG. 5 is a conceptual drawing for describing a screen.

FIG. 6 is a conceptual drawing for describing correction of a spot region whose major axis extends in a P direction.

FIG. 7 is a conceptual drawing for describing correction of a spot region whose major axis extends in a Q direction.

FIG. 8 is a conceptual drawing for describing correction of a spot region according to a second embodiment.

FIG. 9 is a block diagram illustrating an electric structure of the exposure device and the control device according to a third embodiment.

FIG. 10 is a cross-sectional view illustrating one form of electronic apparatuses (image forming apparatus).

### DESCRIPTION OF EXEMPLARY EMBODIMENTS

### A. First Embodiment

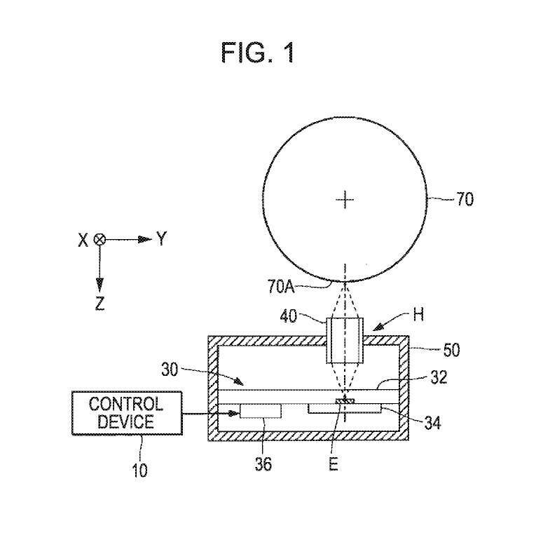

FIG. 1 is a cross-sectional view illustrating a partial structure of an image forming apparatus according to a first embodiment of the invention. As illustrated in this drawing, an image forming apparatus includes a photosensitive drum 70, an exposure device (line head) H, and a control device 10. The photosensitive drum 70 has an exposure surface (an image formation surface) 70A, on which an electrostatic latent image is to be formed, as its outer surface. The exposure device H forms an electrostatic latent image on the exposure surface 70A by exposing the photosensitive drum 70. The control device 10 controls operations of the exposure device H. The photosensitive drum 70 is supported by a rotating shaft extending along the X direction (main scanning direction) and rotates while causing the exposure surface 70A to face the exposure device H. As a result, a portion of the exposure surface 70A that faces the exposure device H relatively moves in the Y direction (sub-scanning direction) with respect to the exposure device H.

As Illustrated in FIG. 1, the exposure device H includes a light emitting device 30, a converging-lens array 40, and a light-shielding holding member 50 holding both components. The light emitting device 30 includes a light transmitting substrate 32, n light-emitting elements E (n is a natural number), a sealing member 34, and a driving circuit 36. The substrate 32 is supported in an attitude whose direction of the length is the X direction. The light-emitting elements E are aligned in the X direction on a surface of the substrate 32 that is remote from the photosensitive drum 70. The sealing member 34 is fixed on the substrate 32 and seals each of the light-emitting elements E. The driving circuit 36 is implemented on the substrate 32.

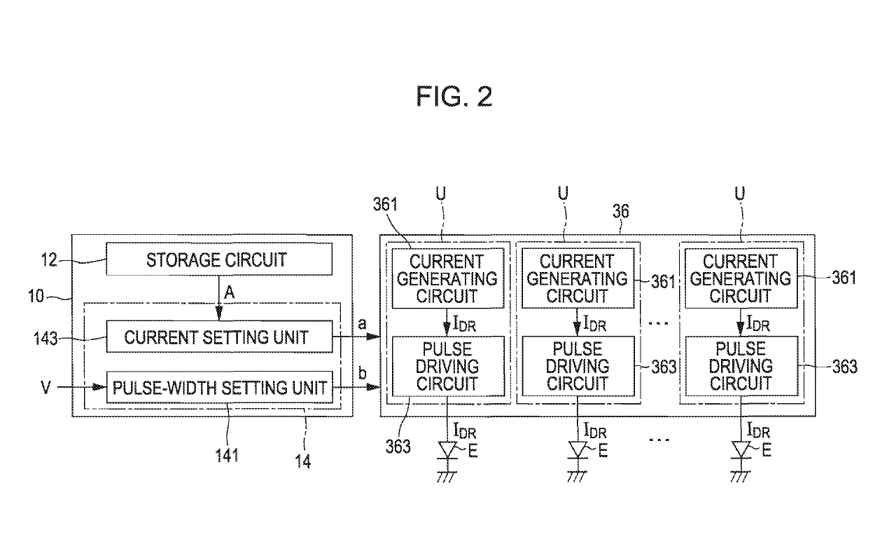

FIG. 2 is a block diagram that illustrates a functional structure of the control, device 10 and the light emitting device 30. The light-emitting element E is an organic light-emitting diode element in which a light-emitting layer made of an organic electroluminescent material is disposed between an anode and an opposed cathode. The driving circuit 36 causes the light-emitting element E to emit light by outputting a drive current I_{DR} under control of the control device 10. The driving circuit 36 may be implemented on the substrate 32 in the form of an IC chip or may include a thin-film transistor formed on the substrate 32 together with the light-emitting element E.

As illustrated in FIG. 2, the driving circuit 36 includes n unit circuits U individually corresponding to the n light-emitting elements E. Each of the unit circuits U is a circuit that controls the drive current I_{DR} to be supplied to a single light-emitting element E and includes a current generating circuit 361 and a pulse driving circuit 363. The current generating circuit 361 generates the drive current I_{DR} having a current value “a” indicated by the control device 10. The pulse driving circuit 363 outputs the drive current I_{DR} in a period of time corresponding to a pulse width “b” indicated by the control device 10 to the light-emitting element E and stops outputting the drive current I_{DR} in the remaining period of time.

The control device 10 includes a storage circuit 12 and a control unit 14. The storage circuit 12 (e.g., read-only memory (ROM)) stores a correction value “A” for each of the n light-emitting elements E. The significance of the correction value A and a method for setting the correction value A will be described below.

The control unit 14 receives an image signal V supplied thereto. The image signal V is a signal that indicates a gray-scale level for the light-emitting element E. The control unit 14 includes a pulse-width setting unit 141 and a current setting unit 143. The pulse-width setting unit 141 sets the pulse width b corresponding to the image signal V for each of the light-emitting elements E and indicates the pulse width b to the corresponding pulse driving circuit 363. The current setting unit 143 sets the current value “a” corresponding to the correction value A stored in the storage circuit 12 for each of the light-emitting elements E and indicates the current value “a” to the corresponding current generating circuit 361. For example, the current setting unit 143 sets the current value “a” by multiplying a predetermined initial value by the correction value A. As described above, the luminous intensity (energy intensity) of light emitted from each of the light-emitting elements E is set using the current value “a” corrected on the basis of the correction value A, and the length of time of emission of each of the light-emitting elements E is controlled using the pulse width b corresponding to the image signal V (pulse-width modulated).

As illustrated in FIG. 1, the converging-lens array 40 is disposed in a gap between the light emitting device 30 and the photosensitive drum 70. Light emitted from each of the light-emitting elements E passes through the substrate 32, is converged by the converging-lens array 40, and then reaches the exposure surface 70A of the photosensitive drum 70. As a result, an erect image corresponding to light emitted from the light-emitting element E is formed on the exposure surface 70A.

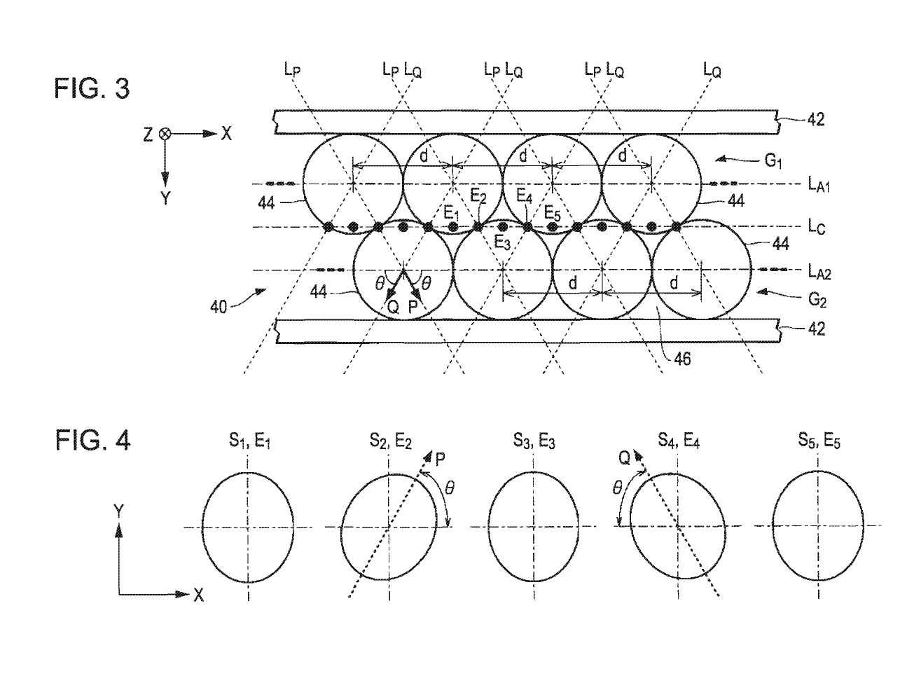

FIG. 3 is a plan view that illustrates a structure of the converging-lens array 40, looking from the photosensitive drum 70. As illustrated in this drawing, the converging-lens array 40 includes two fiber-reinforced plastic (FRP) plates 42, a plurality of gradient-index lenses 44, and a light-shielding filler 46 (e.g., silicon). The FRP plates 42 face each other with a gap therebetween. The gradient-index lenses 44 are aligned in the gap between the two FRP plates 42, and the central axis (optical axis) of each of the gradient-index lenses 44 is oriented in a predetermined direction (z direction). The gap among the gradient-index lenses 44 is filled with the filler 46. Each of the gradient-index lenses 44 is a circular cylindrical condensing unit with a variation of refractive index decreasing with an increase in the distance from the central axis in a transverse plane. As one example of the converging-lens array 40, a SELFOC lens array (SLA) available from Nippon Sheet Glass Co., Ltd. can be suitably used. “SELFOC” is a registered trademark of Nippon Sheet Glass Co., Ltd.

As illustrated in FIG. 3, the plurality of gradient-index lenses 44 are aligned in two rows in the X direction in a staggered arrangement. More specifically, the plurality of gradient-index lenses 44 are divided in two groups G1 and G2. The group G1 consists of gradient-index lenses 44 whose central axes pass through a straight line LA1 in the X direction aligned with a pitch d (the diameter of each of the gradient-index lenses 44). The group G2 consists of gradient-index lenses 44 whose central axes pass through a straight line LA2, which is parallel to the straight line LA1, aligned with the pitch d. The group G1 is in contact with and the group G2. The group G1 is offset from the group G2 by half the pitch d (i.e., d/2) in the X direction. Therefore, the gradient-index lenses 44 of the group G1 and the gradient-index lenses 44 of the group G2 are adjacent to each other along a straight line LP extending in a P direction inclined an elevation angle θ (θ=60°) with respect to the positive side in the X direction (or a straight line LQ extending in a Q direction inclined the elevation angle θ with respect to the negative side in the X direction) That is, the plurality of gradient-index lenses 44 are arranged across a planar array along the X direction and the P direction (or Q direction).

As indicated with solid circles in FIG. 3, the plurality of light-emitting elements E (E1 through E5) are linearly aligned along a straight line LC in the X direction, the straight line LC being equally spaced from the straight lines LA1 and LA2. Because the pitch of the light-emitting elements E differs from the pitch of the gradient-index lenses 44, the relative positional relationships to the gradient-index lenses 44 vary among the light-emitting elements E. For example, the position of the light-emitting element E1 in the X direction matches with the central axis of a gradient-index lens 44 in the group G1, whereas the light-emitting element E2 lies on a straight line LP that connects the central axis of a gradient-index lens 44 in the group G1 and the central axis of a gradient-index lens 44 belonging to the group G2 together.

FIG. 4 are conceptual drawings illustrating the shape of each of spot regions S (spot regions S1 through S5 corresponding to light-emitting elements E1 through E5) formed on the exposure surface 70A in response to light emitted from the light-emitting elements E1 through E5 when energy of light emitted from the light-emitting elements E is not corrected on the basis of the correction value A (hereinafter referred to as “in the case where correction has not been made”). As illustrated in FIG. 4, the shape of the spot region S formed by each of the light-emitting elements E varies depending on the positional relationship between the light-emitting element E and the gradient-index lens 44.

For example, the spot region S1 formed by the light-emitting element E1 has a substantially circular shape (or an elliptical shape that is slightly longer in the Y direction). This is similar to the spot region S3 formed by the light-emitting element E3 and the spot region S5 formed by the light-emitting element E5. In contrast, the spot region S2 formed by the light-emitting element E2 has an elongated shape (elliptical shape) whose major axis extends in the P direction, which is inclined an elevation angle θ with respect to the X direction, (i.e., the direction of alignment of the gradient-index lenses 44 of the group G1 and the gradient-index lenses 44 of the group G2). Similarly, the spot region S4 formed by the light-emitting element E4 is an elongated shape whose major axis extends in the Q direction, which is inclined an elevation angle θ with respect to the X direction.

If the shapes and/or the directions of the major axes of the spot regions S vary, as described above, non-uniformity of a gray-scale level appears in an image output from an image forming apparatus more noticeably than a case in which the shapes of the spot regions S are uniformed to a circular shape. When it is necessary to represent a pseudo-halftone using a screen having many dots (halftone screen), non-uniformity of a gray-scale level would be particularly marked, as described below.

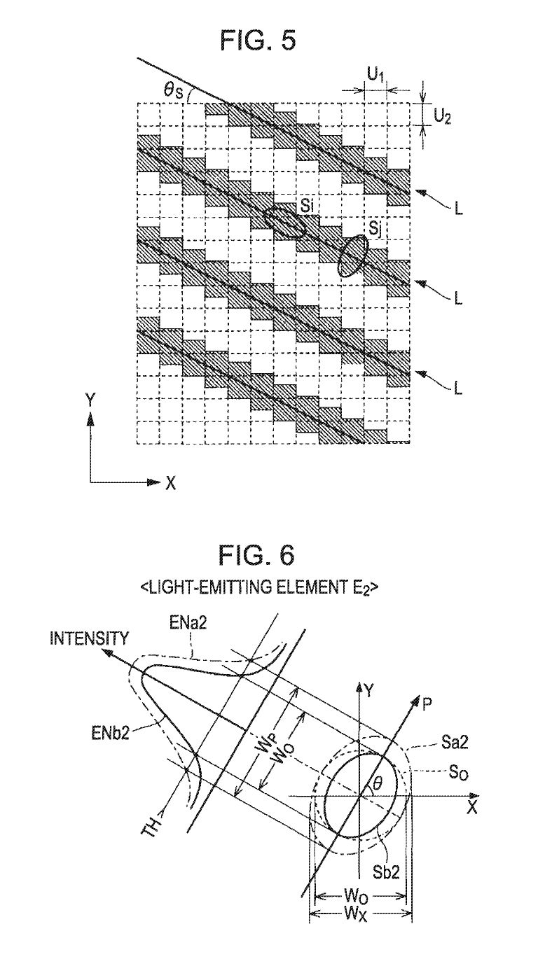

FIG. 5 is a conceptual drawing that illustrates a screen formed as a latent image on the exposure surface 70A of the photosensitive drum 70, the screen having many lines L in which many dots are aligned (diagonally shaded areas in this drawing). A section U1 in FIG. 5 refers to an area radiated with light emitted from a single light-emitting element E. A section U2 in FIG. 5 refers to an area that can be exposed in a single horizontal scanning period. As illustrated in FIG. 5, the provision of equally spaced many lines L inclined a predetermined angle θs (hereinafter referred to as a “screen angle”) with respect to the X direction enables representation of a pseudo-halftone corresponding to the width of each of the lines L or the gap between the lines L.

In the case of a spot region having an elongated shape whose major axis extends in a direction that is substantially parallel to the lines L, like a spot region Si illustrated in FIG. 5, the spot regions S formed by adjacent light-emitting elements E in the X direction overlap each other. Therefore, energy that exceeds an intended amount of energy (original energy provided to a single spot region S) is provided to overlapping portions of the spot regions S in the exposure surface 70A. In contrast, in the case of a spot region having an elongated shape whose major axis extends in a direction that is substantially perpendicular to the lines L, like a spot region Sj illustrated in FIG. 5, the spot regions S formed by adjacent light-emitting elements E in the X direction do not overlap each other. Therefore, non-uniformity occurs in which the adjacent areas of the spot region Si have a darker gray-scale level than the adjacent areas of the spot region Sj. Depending on conditions for image formation, the adjacent areas of the spot region Sj may have a darker gray-scale level than the adjacent areas of the spot region Si.

The correction value A for each of the light-emitting elements E is determined through a first process and a second process, which are described below, such that non-uniformity of a gray-scale level resulting from variations (deformation) in shape among the spot regions S is suppressed. The first process is a process that identifies an elongated soot region S whose major axis extends in a direction inclined toward the X direction (P or Q direction). That is, such an elongated spot region S is identified on the basis of a result of capturing spot regions S formed on the exposure surface 70A in response to light emitted from the light-emitting elements E using an image pickup element (e.g., CCD element) in the case where correction has not been made. For example, in FIG. 4, the spot region S2 formed by the light-emitting element E2 and the spot region S4 formed by the light-emitting element E4 are identified.

The second process is a process that determines the correction value A such that an outer dimension in the direction of the major axis of the spot region S identified in the first process is made to be equal or close to a target value. The details of the second process will be described below.

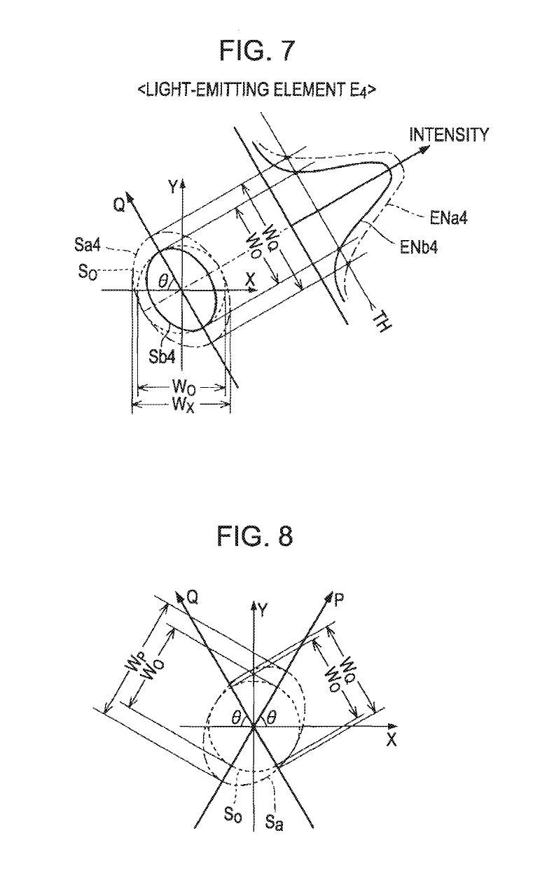

FIGS. 6 and 7 are conceptual drawings that illustrate the relationship between the intensity of energy provided to the exposure surface 70A in response to light emitted from the light-emitting element E and the outer dimension of the spot region S formed on the exposure surface 70A. As illustrated in FIGS. 6 and 7, a region of the exposure surface 70A exhibiting that the intensity of energy provided by the light emitted from the light-emitting element E exceeds a predetermined threshold TH is defined as the spot region S. The present embodiment assumes that the threshold TH is a fixed value. However, the threshold TH may be set at a value calculated by multiplying a peak value of the energy in the spot region S by a predetermined coefficient. FIGS. 6 and 7 also illustrate a spot region S0 which is not deformed (i.e., an ideal spot region S). Since the light-emitting element E has a circular shape, the spot region S0, which is an erect image of the light-emitting element E, has a circular shape having a diameter of W0.

A spot region Sa2 illustrated in FIG. 6 is a spot region S formed by the light-emitting element E2 in the case where correction has not been made (the spot region S2 illustrated in FIG. 4). The correction value A for the light-emitting element E2 identified in the first process is determined such that a dimension WP in the direction of the major axis of the spot region Sa2 (in other words the P direction in which the gradient-index lenses 44 are arranged) is made to be equal or close to a target value W0 (i.e. the diameter of the ideal spot region S0). In the present embodiment, the correction value A for the light-emitting element E2 is determined such that the light-emitting element E2 forms a spot region Sb2 reduced from the spot region Sa2 formed in the case where correction has not been made so that the dimension WP of the major axis along the P direction is aimed to be equal to the target value W0. That is, the correction value A for the light-emitting element E2 is a numerical value that causes the drive current I_{DR} to be supplied to the light-emitting element E2 (i.e., the intensity of light emitted from the light-emitting element E2) to decrease.

If it is assumed that the spot region Sa2 is formed by the light-emitting element E2 supplying energy ENa2 to the exposure surface 70A in the case where correction has not been made, energy ENb2 provided to the corrected spot region Sb2 can be represented by the following expression (1):

ENb2=α×{W0/(W0+δ1)}×ENa2 (1)

where a variable δ1 is a difference value (671=WP−W0 between the dimension WP of the major axis of the spot region Sa2 formed in the case where correction has not been made, and the target value W0 and a coefficient α is a numerical value used for adjusting the degree of making the dimension of the corrected spot region Sb2 in the direction the major axis be equal or close to the target value W0.

As previously described with reference to FIG. 5, non-uniformity of a gray-scale level appearing on a screen becomes more noticeable when the direction of the major axis of the spot region S is nearer the direction of the line L (that is, the overlapping portions of the adjacent spot regions S increase). Therefore, the coefficient α is determined for each of the light-emitting elements E such that the coefficient α increases with a decrease in an angle (θ−θs) between the P direction and the line L of the screen.

In practice, the numerical value of “α×{W0/(W0+δ1)}” in expression (1) is stored in the storage circuit 12 as the correction value A. Because the current value “a” is determined by multiplying the correction value A by an initial value, light emitted from the light-emitting element E2 provides the exposure surface 70A with the energy ENb2 represented by expression (1). In other words, the spot region Sb2 illustrated In FIG. 6 is formed.

The correction value A for the light-emitting element E4 identified in the first process is determined under similar conditions. That is, as illustrated in FIG. 7, the correction value A for the light-emitting element E4 is determined such that the light-emitting element E4 forms a spot region Sb4 reduced from the spot region Sa4 formed in the case where correction has not been made so that the dimension WQ of the major axis along the Q direction is made to be equal or close to a target value W0. For example, as illustrated in FIG. 7, if it is assumed that the spot region Sa4 is formed by the light-emitting element E4 supplying energy ENa4, energy ENb4 provided to the corrected spot region Sb4 can be represented by the following expression (2):

ENb4=α×{W0/(W0+δ2)}×ENa4 (2)

where a variable δ2 is a difference value (δ2=WQ−W0) between the dimension WQ of the major axis of the spot region Sa4 formed in the case where correction has not been made and the target value W0 and, as described with reference to the light-emitting element E2, the coefficient α is set at a numerical value corresponding to, for example, the screen angle θs. The numerical value of “α×{W0/(W0+δ2)}” in expression (2) is stored in the storage circuit 12 as the correction value A for the light-emitting element E4.

When the major axis of the spot region S is inclined with respect to the X direction, as illustrated in FIGS. 6 and 7, a dimension Wx of the spot region S (Sa2, Sa4) in the X direction formed in the case where correction has not been made is near a target value W0. Therefore, even if energy of light emitted from the light-emitting element E is corrected such that the dimension Wx of the spot region S in the X direction is made to be equal to the target value W0 as described in the above-mentioned patent document, the difference between a dimension in the direction of the major axis of the spot region S and the target value W0 is not eliminated. As a result, non-uniformity of a gray-scale level illustrated in FIG. 5 cannot be sufficiently suppressed. In contrast, according to the present embodiment, since energy of light emitted from the light-emitting element E is corrected such that a dimension (WP, WQ) of the spot region S in the direction of the major axis is made to be equal or close to the target value W0, non-uniformity of a gray-scale level resulting from variations in shape among the spot regions S can be sufficiently suppressed. In addition, according to the present embodiment, because the correction value A is determined after the direction of alignment of the gradient-index lenses 44 (P directions Q direction) has been identified as the direction of the major axis of the spot region S, the present embodiment also has the advantage of obviating the necessity to strictly measure the direction of the major axis of the spot region S.

As described with reference to FIG. 5, non-uniformity of a gray-scale level resulting from variations in shape among the spot regions S is particularly marked when a screen is formed on the exposure surface 70A. In the present embodiment, since the correction value A is adjusted in response to the coefficient α determined from the relationship between the direction of the screen angle θs and the direction of the major axis of the spot region S (P direction, Q direction), non-uniformity of a gray-scale level appearing on a screen image can be suppressed more effectively than a structure in which the correction value A is corrected independently of the screen angle δs.

### B. Second Embodiment

The second embodiment of the invention will now be described below. In the first embodiment, the correction value A is determined on the basis of the dimension of the spot region S in the direction of the major axis formed in the case where correction has not been made. In the present embodiment, when a spot region S has an elongated shape whose major axis extends in the P direction and another spot region S has an elongated shape whose major axis extends in the Q direction, the P direction and the Q direction are identified in the first process, and then, in the second process, the correction value A is determined on the basis of a difference value between the dimension of a spot region S in the P direction and that in the Q direction. The components having substantially the same operations and functions in the present embodiment as those in the first embodiment have the same reference numerals as those in the first embodiment, and the detailed description thereof are omitted as appropriate.

FIG. 8 is a conceptual drawing that illustrates the relationship between the spot region Sa formed in the case where correction has not been made and a target spot region S0. In FIG. 8, it is assumed that the spot region Sa formed in the case where correction has not been made is an elongated shape whose major axis extends in the P direction (for example, the spot region Sa2 illustrated in FIG. 6). A dimension WP illustrated in FIG. 8 refers to the dimension of the spot region Sa in the P direction. A dimension WQ illustrated in FIG. 8 refers to the dimension of the spot region Sa in the Q direction. In the present embodiment, the correction value A is determined such that energy ENa provided to the spot region Sa formed in the case where correction has not been made and energy ENb provided to the corrected spot region S satisfy the following expression (3):

ENb=α×{W0/(W0+δ3)}×ENa (3)

where δ3 is the absolute value of the difference between the dimension WP in the P direction and the dimension WQ in the Q direction (δ3=|WP−WQ|).

In practice, the numerical value of “α×{W0/(W0+δ3)}” in expression (3) is stored in the storage circuit 12 as the correction value A. The coefficient α is set for each of the light-emitting elements E, for example, in response to the screen angle θs, as is the case of the first embodiment. In the foregoing description, a spot region Sa whose major axis extends in the P direction has been described by way of example. However, a spot region Sa whose major axis extends in the Q direction is also corrected on the basis of the correction value A calculated from expression (3) in a similar way.

In the first exemplary embodiment, the correction value A for the light-emitting element E2 is determined from the dimension WP in the P direction, whereas the correction value A for the light-emitting element E4 is determined from the dimensions WQ in the Q direction. This means that it is necessary to determine whether, for each of the light-emitting elements E, the P direction or the Q direction is used for correction. In contrast, according to the present embodiment, since the correction value A is determined on the basis of the difference value between the dimension WP in the P direction and the dimension WQ in the Q direction, the present embodiment has the advantage of obviating the necessity to determine the relationship between the P and Q directions and the size of a dimension of the spot region S.

### C. Third Embodiment

The third embodiment will now be described below. The components having substantially the same operations and functions in the present embodiment as those in the first embodiment have the same reference numerals as those all the first embodiment, and the detailed description thereof are omitted as appropriate.

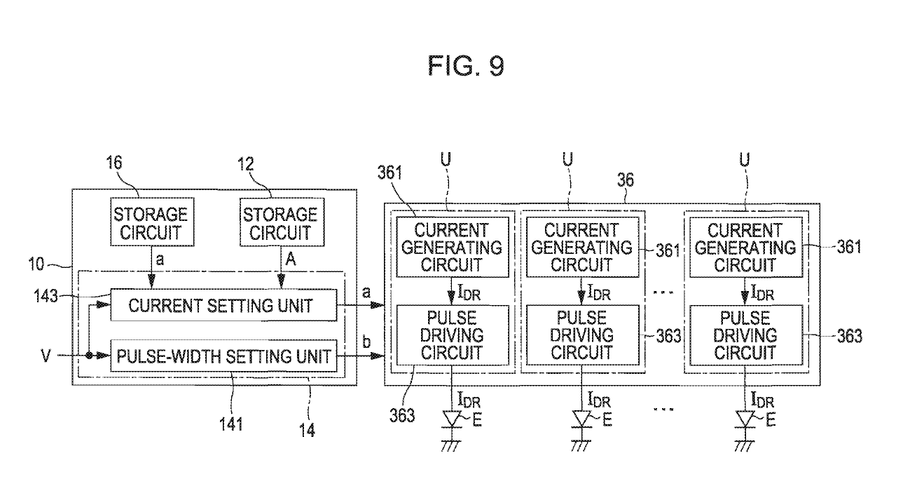

FIG. 9 is a block diagram that illustrates a functional structure of the control device 10 and the light emitting device 30. As illustrated in this drawing, the control device 10 according to the present embodiment includes a storage circuit 16 (e.g., ROM) in addition to the components illustrated in FIG. 2. The storage circuit 16 may be integrated into the storage circuit 12 or be an independent circuit.

The storage circuit 16 stores a conversion table. The conversion table is a table in which a set of a correction value A and a gray-scale level for a light-emitting element E is associated with a current value “a”. For each of the light-emitting elements E, the current setting unit 143 retrieves, from the conversion table, a current value “a” associated with a correction value A stored in the storage circuit 12 and a gray-scale level specified for the light-emitting element E by an image signal V and outputs it to the driving circuit 36. As a result, a current value “a” of a drive current I_{DR} to be supplied to a single light-emitting element E (in addition, energy of light emitted from the light-emitting element E) is controlled to a level corresponding to a correction value A and a gray-scale level for the light-emitting element E.

The correction value A for the light-emitting element E is determined for each of the light-emitting elements E such that the corrected spot region S formed in the case where a predetermined gray-scale level is specified for the light-emitting element E satisfies a condition described in the first or second embodiment (e.g., expressions (1) and (2) or (3)). That is, the correction value A for the light-emitting element E is determined such that the dimension in the direction of the major axis of the corrected spot region S formed by the light-emitting element E to which a predetermined gray-scale level is specified is made to be equal or close to a target value W0.

The optimum value of the current value “a” of the drive current I_{DR} to be supplied to the light-emitting element E may vary depending on a gray-scale level specified to the light-emitting element E. As described above, in the present embodiment, since the current value “a” is set on the basis of both the correction value A and the gray-scale level, non-uniformity of a gray-scale level can be suppressed by correction based on the correction value A, while at the same time the current value “a” of the drive current I_{DR} can be optimized for each of the light-emitting elements E by appropriately setting the content of the conversion table.

### D. Modifications

The embodiments described above can be variously modified. Several specific examples of modifications are described below. The modifications described below may be combined as appropriate.

### (1) First Modification

In the above embodiments, the correction value A is determined on the basis of the dimension (WP, WQ) of the spot region S in the direction of alignment of the gradient-index lenses 44 in the converging-lens array 40 (P direction, Q direction). However, it is not necessarily required to use the direction of alignment of the gradient-index lenses 44. That is, the direction of the major axis of the Spot region S formed in the case where correction has not been made (direction of the major axis of the spot region S approximating an elliptical shape) may be measured, and the correction value A may be determined on the basis of the dimension of the spot region S in the measured direction.

### (2) Second Modification

In the above embodiments the current value “a” of the drive current I_{DR} is controlled depending on the correction value A. However, a method for correcting the form (e.g., size or shape) of a spot region S may be modified as appropriate. For example, instead of or in addition to a structure in which the current value “a” is controlled, a structure in which a pulse width b of the drive current I_{DR} is controlled may be used. An exposure device that uses a voltage-driven light-emitting element, which emits light upon application of a voltage (hereinafter referred to as a “drive voltage”), uses a structure in which at least one of the voltage value of the drive voltage and the pulse width is controlled depending on the correction value A.

In the third embodiment, correction values A and gray-scale levels are associated with each other in a conversion tale. A structure n which the current setting unit 143 calculates a current value “a” by predetermined computation using a correction value A and a gray-scale level as arguments may be used. Specific details on processing depending on the correction value A and a direct subject to be corrected by the correction value A can be freely set as long as energy of light emitted from a light-emitting element E is corrected on the basis of a correction value A.

### (3) Third Modification

The form of alignment of light-emitting elements E and alignment of gradient-index lenses 44 may be appropriately modified. For example, a structure in which a plurality of light-emitting elements E are aligned in a plurality of rows (e.g., two rows in a staggered arrangement) or a structure in which a plurality of gradient-index lenses are aligned in three or more rows may be used.

### (4) Fourth Modification

In the above embodiments, the correction value A is determined on the basis of the dimension of the spot region S in the direction of the major axis. However, the correction value A may be determined by using both the above-described method and another method. For example, a procedure of, first, determining an initial value of the correction value A such that variations in quantities of light from the light-emitting elements E resulting from errors of characteristics of the light-emitting elements E (such that the light quantities are made to be uniform) and, second, adjusting the correction value A depending on the dimension in the direction of the major axis of the spot region S corrected using the initial value of the correction value A (that is, determining the correction value A for the light-emitting element E so as to satisfy a condition described in at least one of the above-described embodiments) can be used.

### (5) Fifth Modification

The organic light-emitting diode element is merely an example of the light-emitting element. For example, the organic light-emitting diode element according to the above-described embodiments can be replaced with any one of various light-emitting elements, such as an inorganic EL element, a light emitting diode (LED) element, and laser diode element.

### E. Applications

A specific form of an electronic apparatus (image forming apparatus) that uses the exposure device H will now be described below.

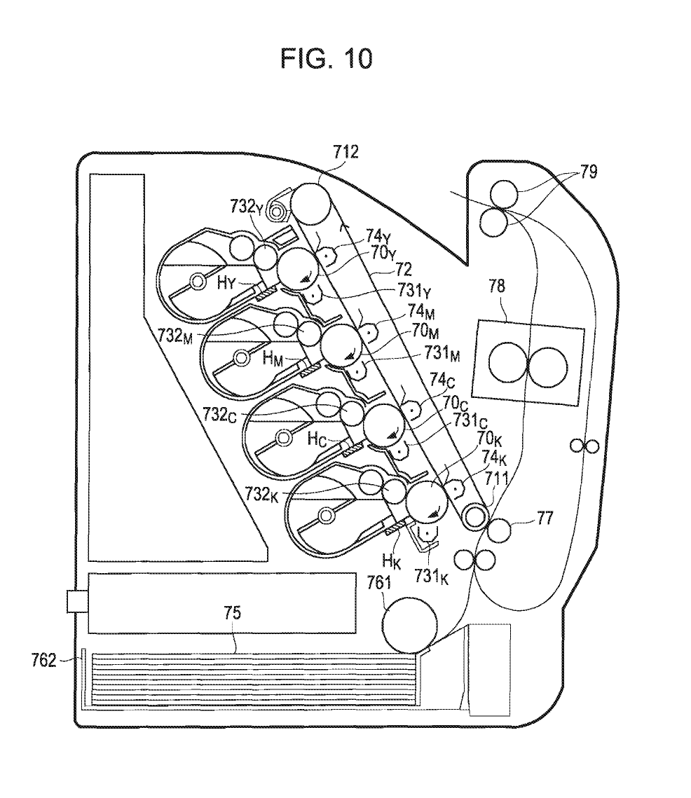

FIG. 10 is a cross-sectional view that illustrates a structure of the image forming apparatus. The image forming apparatus is a full-color tandem image forming apparatus and includes four exposure devices H (HK, HC, HM, HY) according to at least one of the above-described embodiments and four photosensitive drums 70 (70K, 70C, 70M, 70Y) corresponding to the respective exposure devices H. As illustrated in FIG. 1, a single exposure device H is disposed so as to face an exposure surface 70A (outer surface) of a corresponding photosensitive drum 70. Letters affixed to reference numerals, K, C, M, and Y, indicate that the components denoted by the reference numerals are used for formation of a visible images of black (K), that of cyan (C), that of magenta (M), and that of yellow (Y), respectively.

As illustrated in FIG. 10, an endless intermediate transfer belt 72 is wound around a driving roller 711 and a driven roller 712. The four photosensitive drums 70 are spaced at predetermined intervals and disposed adjacent to the intermediate transfer belt 72. The photosensitive drums 70 are rotated in synchronism with driving of the intermediate transfer belt 72.

In addition to the exposure devices H, corona charging devices 731 (731K, 731C, 731M, 731Y) and developing devices 732 (732K, 732C, 732M, 732Y) are disposed adjacent to the photosensitive drums 70. Each of the corona charging devices 731 uniformly charges the exposure surface 70A of the corresponding photosensitive drum 70. Each of the exposure devices H exposes the charged exposure surface 70A, thereby forming an electrostatic latent image. Each of the developing devices 732 attaches a developer (e.g., toner) to the electrostatic latent image, thereby forming a visible image (visualized image) on the photosensitive drug 70.

As described above, sequentially transferring visible images of different colors (black, cyan, magenta, and yellow) formed on the respective photosensitive drums 70 onto the surface of the intermediate transfer belt 72 (primary transfer) forms a visible full-color image. Four primary transfer corotrons (transferring devices) 74 (74K, 74C, 74M, 74Y) are disposed inside the intermediate transfer belt 72. Each of the primary transfer corotrons 74 ectrostatically draws the visible image from the corresponding photosensitive drum 70, thereby transferring the visible image onto the intermediate transfer belt 72 passing through between the exposure surface 70A and the primary transfer corotron 74.

Sheets (recording media) 75 are fed one by one from a paper feed cassette 762 by a pick-up roller 761 and transported to a nip between the intermediate transfer belt 72 and a secondary transfer roller 77. The full-color visible image formed on the surface of the intermediate transfer belt 72 is transferred onto one side of the sheet 75 by the secondary transfer roller 77 (secondary transfer). The sheet 75 is transported so as to pass through between a pair of fixing rollers 78, and the image is thus fused. The sheet 75 on which the visible image has been fused through the above process is ejected by a pair of erect rollers 79.

Because the image forming apparatus described above uses an organic light-emitting diode element as a light source, the image forming apparatus can be smaller than a structure that uses a laser scanning optical system. The exposure device H can be used in image forming apparatuses other than the above-described image forming apparatus. For example, the exposure device H can be used in an image forming apparatus that uses a rotary developing system, an image forming apparatus that transfers a visible image directly onto a sheet from the photosensitive drum 70 without use of the intermediate transfer belt, and a monochrome image forming apparatus.

Applications of the exposure device H are not limited to exposure to the image bearing member. For example, the exposure device H can be used in an image reading apparatus as an illuminating device for irradiating a reading target (e.g., document) with light. Examples of this type of the image reading apparatus include a scanner, a reading portion of, for example, a copier and a facsimile machine, a barcode reader, and a two-dimensional image code reader for reading two-dimensional image code (e.g., QR code®).

The entire disclosure of Japanese Patent Application No. 2006-303653, filed Nov. 9, 2006 is expressly incorporated by reference herein.

What is claimed is:

1. A method for determining a correction value used for correction of energy of light emitted from each of a plurality of light-emitting elements for exposing a surface to be exposed, the light-emitting elements being arranged in a first direction, the method comprising:
identifying, from among a plurality of spot regions formed on the surface in response to the light being emitted from the plurality of light-emitting elements, an elongated spot region whose major axis extends in a direction inclined with respect to the first direction; and
determining a correction value such that a dimension of the identified spot region in a direction of the major axis is made to be equal or close to a target value.

2. The method according to claim 1, wherein the light emitted from the light-emitting elements passes through a plurality of converging units arranged across the first direction and a second direction inclined with respect to the first direction and then reaches the surface, and the correction value is determined such that a dimension of the identified spot region in the second direction is made to be equal or close to the target value.

3. The method according to claim 1, wherein the correction value is determined on the basis of a relationship between a direction of a screen angle of an image formed on the surface and the direction of the major axis of the identified spot region.

4. A method for determining a correction value used for correction of energy of light emitted from each of a plurality of light-emitting elements for exposing a surface to be exposed, the light-emitting elements being arranged in a first direction, the method comprising:
identifying, from among a plurality of spot regions formed on the surface in response to the light being emitted from the plurality of light-emitting elements, an elongated spot region whose major axis extends in a first axial direction inclined with respect to the first direction and an elongated spot region whose major axis extends in a second axial direction, the second axial direction being inclined with respect to the first direction in a direction different from the first axial direction, and identifying the first axial direction and the second axial direction; and
determining, for each of the plurality of light-emitting elements, a correction value on the basis of a difference value between a dimension in the first axial direction and a dimension in the second axial direction of a spot region formed by the plurality of light-emitting element.

5. An exposure device comprising:
a plurality of light-emitting elements that expose a surface to be exposed, the plurality of light-emitting elements being arranged in a first direction; and
a storage circuit that stores a correction value for each of the plurality of light-emitting elements,
wherein the exposure device controls energy of light emitted from the light-emitting element on the basis of the correction value for the light-emitting element, and,
the correction value stored in the storage circuit has been determined such that a dimension of an elongated spot region whose major axis extends in a direction inclined with respect to the first direction in a direction of the major axis, the elongated spot region being identified from a plurality of spot regions formed on the surface in response to the light being emitted from the plurality of light-emitting elements, is made to be equal or close to a target value.

6. An image forming apparatus comprising:
an exposure device according to claim 5;
an image bearing member having the surface on which a latent image is to be formed by exposure performed by the exposure device; and
a developing unit that forms a visible image by applying a developer to the latent image formed on the image bearing member.
